(19) United States
(12) Patent Application Publication
(10) Pub. No.: US 2016/0350500 A1
(43) Pub. Date: Dec. 1, 2016

(54) Global Healthcare Exchange

(71) Applicant: Anuthep Benja-Athon, New York, NY (US)

(72) Inventor: Anuthep Benja-Athon, New York, NY (US)

(21) Appl. No.: 14/721,981

(22) Filed: May 26, 2015

(51) Int. Cl. G06F 19/00

(52) U.S. Cl. CPC G06F 19/328

(57) ABSTRACT

A system for rendering and controlling healthcare through a network, the system having a mechanism possessing a cloud intelligence for instructing a mechanism for rendering, managing, controlling and dispensing healthcare and fees payments based on healthcare dispensations and usages, for disseminating and sharing compilations of relational medical-business data and for rendering safekeeping and security for protecting the system in and among networked repositories.

This is a continuation-in-part of application Ser. No. 14/606,956 entitled Billion Recounts of Events Ahead of Days filed Jan. 27, 2015 which is pending and continuation-in-part of application Ser. No. 11/803,621 filed May 16, 2007, Ser. No. 12/069,409 filed Feb. 11, 2008, Ser. No. 12/072,097 filed Feb. 25, 2008, Ser. No. 12/080,433 filed Apr. 3, 2008, Ser. No. 12/156,674 filed Jun. 4, 2008, Ser. No. 12/321,141 filed Jan. 16, 2009, Ser. No. 12/381,654 filed Mar. 16, 2009, Ser. No. 12/584,718 filed Sep. 11, 2009, Ser. No. 12/592,714 filed Dec. 2, 2009, Ser. No. 12/799,207 filed Apr. 21, 2010,12/658,112 filed Feb. 3, 2010, Ser. No. 12/804,588 filed Jul. 26, 2010, Ser. No. 12/924,054 filed Sep. 20, 2010, Ser. No. 12/930,397 filed Jan. 6, 2011, Ser. No. 13/134,139 filed May 31, 2011, Ser. No. 13/200,196 filed Sep. 21, 2011, Ser. Nos. 13/678,096, 13/730,882 filed Dec. 29, 2012, Ser. No. 12/322,529 entitled The Health-care Exchange II filed Feb. 4, 2009, application Ser. No. 12/592,714 entitled Health-care Exchange IV filed Dec. 2, 2009, and application Ser. No. 11/344,485 entitled Physicians-patients-health-care-buyers accounting system filed Feb. 1, 2006 which were abandoned.

### FIELD OF THE INVENTION

A network for rendering the global healthcare.

### BACKGROUND OF THE INVENTION

Americans can attest that more fixes implemented to healthcare, the more fragmented and worse the current healthcare system. Health care, health care services and products henceforth collectively healthcare heretofore remained mostly inaccessible and rudimentary. Consequently, people's lives, well-being and livelihood are adversely affected and disadvantaged. The present invention, however, provides the best healthcare system for the ultimate and best solution for billions of people at the lowest costs and optimal efficiency.

### SUMMARY OF THE INVENTION

A system for rendering, managing and controlling healthcare through a network, said network comprising networked repositories possessing a mechanism comprising a cloud intelligence for instructing said mechanism how to render, manage and dispense healthcare associating with a fees payments system and to disseminate and share compilations of relational medical-business data among said networked repositories. Said mechanism rendering a safekeeping and an innate security for protecting said system.

### DESCRIPTION OF THE PREFERRED EMBODIMENTS

The present invention is a system and method for rendering said best healthcare for billions of people through a global network of servers including cloud servers, computers, laptops, tablet computers and billions of smartphones having digital cameras and a mechanism for attaching pictures and videos to data, viewing screens and touch-screens. Said devices having repositories. Said repositories comprised processing means and storage means associating with innovative computer programs and external interfaces for removably coupling said networked repositories. Said system inherently created and fostering an adaptable networked-repositories intelligence henceforth cloud intelligence for rendering, controlling and dispensing said global healthcare. Said networked repositories comprising networks of cloud rendering-servers repositories henceforth cloud repositories, repositories in said servers, computers and mobile communication devices including tablet computers and smartphones henceforth networked devices. Said networked repositories for generating, compiling, disseminating and sharing compilations of relational medical-business data and for improving and fostering said cloud intelligence, safekeeping and security Web in and among said networked repositories.

Said cloud intelligence comprised intelligent medical, healthcare and science logics innate in said compilations of relational medical-business data caused by repeated disseminations, sharing, uses and analyses of inclusive and exclusive relational medical-business data in said compilations in said storage means, continua, templates and platforms in and among said networked repositories. Said innovative computer programs instruct processing means how to optimize individual compilations in said storage means such as, but not limited to detecting and correcting deficiencies and defects of relational medical data and relational medical-business data in and among said networked repositories and how to compile and manage said compilations of relational medical-business data with stored compilations in said cloud repositories and networked repositories, and to disseminate and share said compilations in and among said networked repositories thus fostering and improving said cloud intelligence.

Said cloud intelligence for instructing said processing means to process requests to access said compilations of relational medical-business data in and among said networked repositories and for executing and managing said mechanism and said innate security Web. Said cloud intelligence is rendered and fostered by said networked repositories using intelligent medical, healthcare and science logics innate in said compilations of relational medical-business data based on repeated disseminations, sharing, uses and analyses of inclusive and exclusive relational medical-business data in said compilations in said storage means and said continua, templates and platforms in and among said networked repositories including cloud repositories.

Said means comprised a plurality of linked interactive relational templates and platforms for generating, editing, adapting, adding, disseminating and sharing compilations of relational medical-business data in and among said networked repositories, said relational templates and platforms attaching a plurality of rendering application software henceforth apps. Said apps for rendering individual custom and multiple medical-business specialty-specific templates and platforms in individual networked repositories. Said apps are such as, but not limited to, healthcare infrastructure software, enterprise infrastructure software, accounting software, media players software, office suites, information software, product engineering software, media development software, content access software, educational software, simulation software and user-written software such as, but not limited to, spreadsheet templates, form templates, word processor macros, scientific simulations, graphics and animation scripts.

Said templates and platforms comprised individual repository-specific and repositories-specific interactive scrollable or automatically expanding continua of said compilations, each expanding continuum for automatically uploading in the home page in each view screen said compilations in said continua, templates and platforms. Said compilations comprised relational medical data and relational medical-business data comprised diagnosis-specific categories and headings of medical history such as, but not limited to, differential diagnoses, chief complaints, review of systems, physical examination, present illnesses, past medical history, past surgical history, vaccinations, general health, infectious diseases, sources of infections, accidents, injuries, repetitive strain injuries, hospitalizations, social history, family and travel history, assessments and plans, medications, allergies, side-effects, procedures, treatments, therapies, laboratory tests and results.

The compilations of relational medical-business data: Each expanding and interactive continuum get and receive said compilations and disseminate and share said compilations in and among said networked repositories. Said processing means uploading said compilations including said first and second operant associating archives from said storage means into said repository-specific and repositories-specific interactive scrollable or automatically expanding continua and related templates and platforms in said viewing screens. Said continua, templates and platforms possessing said first and second operant associating archives for operating said means.

In and among said networked devices, said first operant associating archives which are interactive icons, buttons and words ubiquitous in said interactive and expanding continua and linked interactive templates and platforms in said viewing screens. As a plurality of one-step gets and one-step processes, said interactive icons, buttons and words when selected and/or touched instruct said processing means to get and display interactive and expanding continua and linked interactive templates and platforms having said repository-specific compilations in individual devices being used by people such as, but not limited to, individual patients. As a plurality of one-step get and one-step process, similarly, said interactive icons, buttons and words when selected and/or touched instruct said processing means to get and display interactive and expanding continua and linked interactive templates and platforms having said repositories-specific compilations in said networked devices of people and entities such as, but not limited to, physicians, healthcare providers, insurance, pharmacies, governments, corporations and companies.

In and among said networked devices and most vitally applicable to said networked mobile communications devices, said second operant associating archives for executing said means, works and products comprising individual anatomical and organ sites represented by numerous interactive 2-dimensional and 3-dimensional human, anatomical parts and organ images and images in videos to which individual and duplicate interactive relational medical data and said compilations from storage means are attached. The spatial positions of said individual and duplications interactive relational medical data and said compilations referencing said human and organ images in said interactive continua, templates and platforms, said spatial positions represent instruction in said computer programs to instruct said processing means how to assign spatial specificity—i.e. adjectives for specifying individual anatomical locations of said medical data associating with said anatomy and organs—to relational spatial-specific labeled medical data associating with said anatomical and organ sites in said storage means, said processing means for assigning said adjectives representing said spatial specificity to said selected relational medical data associating with relevant anatomical and organ parts and sites in said compilations in said storage means whenever individual medical data in said compilations of relational medical-business data in said templates and platforms were selected by individual requesting repositories.

Individual archives comprising compilations of associations of relational spatial-specific labeled medical data associating with anatomical and organ sites in said storage means and viewing screens, said archives are interactive and adaptable in said viewing screens based on additions and editions in said compilations in said continua, templates and platforms and said storage means.

Said spatial specificity are adjectives in medical and non-medical dictionaries such as, but not limited to, anterior, bilateral, central, circular, distal, horizontal, inferior, infra, lateral, left, lower, many, marginal, medial, midline, multiple, new, one, opaque, proximal, rectangular, right, superior, transparent, translucent, unilateral and any combination thereof.

In sum, said second operant associating archives are vital to said mechanism, works and products operating in said networked mobile communication devices and for said mechanism, works and products to adroitly operate in said networked devices.

Said continua, templates and platforms having individual interactive get-function, manage-function, compile-function and share-function icons, buttons and words for linking, associating and expanding said compilations in and among individual repositories and said networked repositories and individual interactive icons, buttons and words for getting, managing, compiling and sharing compilations relational medical-business data in and among relevant continua, templates and platforms in and among said networked repositories.

Said security Web comprised individual adaptable electronic locks and complementary adaptable electronic keys in storage means of said cloud repositories and relevant networked repositories. Each key rendered by said cloud intelligence comprising a compilation of encrypted and randomized networked repository identifications, single or multiple-users identifications, demographics data and adaptable sequences of digital idiosyncratic snippets from said compilations of relational medical-business data generated by and characterizing each repository stored in said storage means of said cloud repositories. Each key is transmitted to be attached to a relevant networked repository, same key stored in said cloud repositories is known as a lock. Said keys and locks are automatically and constantly updated by said cloud repositories. All keys and locks constituting said adaptable security Web having said verification and vigilance protocol.

Said Web functions: individual requesting networked repositories transmitting keys requesting to couple between and among networked repositories. Processing means in said cloud repositories processing the handshakes of keys and locks utilizing said verification and vigilance protocol to scrutinize and match individual keys attaching to individual requesting repositories with corresponding locks in said cloud repositories to render individual electronic handshakes to grant individual clearances and accesses to coupling requesting and targeted repositories including said cloud repositories. Said individual electronic handshakes cause said cloud repositories to transmit individual text and voice messages including security images on said handshakes to requesting and targeted networked repositories.

Cleared requesting repositories having particular access and usage rights indicating individual particular requests for said means having particular works and products in cloud repositories and relevant networked repositories. Each said access and usage rights for specifying how said means, works and products in said cloud repositories and networked repositories are used by requesting repositories. Said access and usage rights are either granted or denied by said cloud repositories or networked repositories. When clearances granted, individual access and usage rights executed by cleared requesting repositories cause said processing means to render said means having particular repository-specific or repositories-specific works and products associating with individual cleared requesting repositories.

Further to supra, taught in said Ser. Nos. 12/322,529 and 12/592,714, whenever said requesting repositories selected relational medical data in said linked interactive relational expandable continua, templates, platforms and said second operant associating archives and submitted said selected having individual diagnosis-specific and categories-specific words, terms and phrases relating to individual relational medical-business data wherein words, terms and phrases representing dispensed amounts, types and characters of dispensations and usages of said healthcare comprising said procedures, treatments, services and products including pharmaceutics and laboratory tests, said selected words, terms and phrases are processed by said processing means to said storage means and automatically generate, calculate and distribute fees payments, debits and credits associating with said dispensations and usages based on stored fees payments by scanning and matching said individual words, terms and phrases with same and similar words, terms and phrases associating with individual fees in dollars and national currencies in relational databases in said cloud repositories. Said processing means automatically compile relational medical-business data having amounts, types and characters of dispensed and used diagnosis-specific and categories-specific associating with said fees payments, debits and credits and tallies in said cloud repositories which disseminate and share said compilations in and among relevant networked repositories.

Said words, terms and phrases are most commonly spoken and hand-written by physicians and allied health providers such as, but not limited to, diverse types of consultations, evaluations, reevaluations, follow ups, examinations, laboratory tests, medical and surgical procedures and treatments and the likes.

In other words, said business data of said relational medical-business data are automatically, instantly and continually generated by business transactions caused by said uses of said words, terms and phrases associating with relevant medical data in said templates and platforms in, between and among networked repositories of devices own and operated by healthcare providers such as, but not limited to, physicians, nurses and other healthcare providers and/or their staff, consumers of said healthcare such as, but not limited to, patients who use and/or own said networked devices especially said billions of smartphones, and health insurance, companies, corporations, employers, institutions, governments and/or their staff and any and all third party payers of said healthcare consumed by individuals. Most efficiently and inexpensively, said real-time business transaction and business data are automatically and accurately generated, accounted and edited between and among said relevant networked repositories.

Said reconstituent means for safeguarding and resurrecting said system and works and products are apps including mobile apps created by said innovative computer programs which instruct processing means in said cloud to disseminate said apps among said networked repositories. Said independent and almost indestructible apps having said mechanism and works and products relevant to said networked repositories. Consequently, said apps in and among billions of networked repositories cause said networked repositories to be equivalent or analogous to a global networked repository more immense than said cloud repositories. Therefore, the integrity of said mechanism and works and products are secured and protected and can function like or even better in all aspects herein than said cloud repositories.

Supra is assisted by said individual interactive get-function, manage-function, compile-function and share-function icons, buttons and words in said interactive electronic continua, templates and platforms; digital images and videos generated by said digital cameras, said images and videos attaching to relational medical-business data generated in and among said networked repositories in particular repositories of mobile communication devices; apps for getting and receiving said relational medical and business data in, from and among said networked repositories; and individual medical data-business-specific blogs.

It is to be understood that said compilations of relational medical-business data are in said storage means are organized as described supra and as diverse medical and surgical specialties-specific medical data and information in all medical and surgical specialties and practices; evidence-based medicine and practice data; data and information in volumes of Physicians' Desk Reference; evidence-based medicine and practice data and information created and fostered in and among said networked repositories; digital images and videos; and all derivatives of said data and information created and used in and among networked repositories.

The present invention uses commercial application software henceforth apps for vital and smart functions such as, but not limited to, rendering interactive custom repository-specific and diagnosis-medical history specific templates and platforms to match and suit peculiar needs of individual networked repositories. Said apps-rendered templates and platforms are downloaded, stored, disseminated and adapted in and among said networked repositories including cloud repositories. Said compilations of relational medical-business data comprise relational structured and unstructured data, real-time data, texts, images, QR codes, bar codes, pictures, videos, research data, breaking news, news, facts, insights, opinions and forecasts. Commercial securities include, but not limited to, fire-walls, encryptions, domain-based message authentication, reporting and conformance.

Although various preferred embodiments of the present invention have been described, it will be appreciated by those skilled in the art that adaptations and variations of said embodiments are and will be made without departing from the spirit and scope of the present invention.

1. A system for rendering and controlling healthcare through a network, said system having a mechanism for rendering, dispensing and controlling dispensations of healthcare in and among networked repositories, said mechanism having a means for rendering, modulating, controlling and dispensing said dispensations and usages possessing an inherent means for automatically generating, calculating and distributing fees payments associating with said dispensations and usages in, between and among networked repositories and a first and a second operant associating archives for executing said means, said means attaching a means for getting, managing including compiling relations of and sharing products of said means in, between and among said networked repositories, said mechanism and associating works and products having attached access and usage rights, and a networked-repositories intelligence known herein as cloud intelligence for instructing and managing said mechanism, and endowing a reconstituent means for safeguarding and resurrecting said system and works and products and an inherent security Web having a verification and vigilance protocol, said reconstituent means and Web for protecting said system, said system comprising:
said networked repositories comprising networks of cloud rendering-servers repositories known herein as cloud repositories, repositories in servers, computers and networks of mobile communication devices including tablets and smartphones having viewing screens including touch-screens and digital camera means for compiling and sharing relational medical-business data henceforth networked devices, said networked repositories having external interfaces for removably coupling repositories among said networked repositories, said networked repositories for generating, compiling, disseminating and sharing relational medical-business data for rendering, dispensing and controlling said dispensations and fees payments, said networked repositories for improving and fostering said cloud intelligence, said networked repositories for generating, fostering and maintaining said security Web in and among said networked repositories,
commercial encryption software, and application software henceforth apps;
each of said networked repositories comprising:
storage means for storing said mechanism and works and products comprising compilations of relational medical data and relational medical-business data, access and usage rights, innovative computer programs, commercial computer programs and software, cloud intelligence, keys and locks of said networked repositories and said verification and vigilance protocol;
reconstituent means for safeguarding and resurrecting said system and works and products;
processing means for rendering, executing and managing said mechanism, works and products according to computer programs and software for rendering, executing and managing said mechanism, works and products;
said computer programs and software attaching to said processing means, said computer programs and software for instructing said processing means how to render, execute and manage said mechanism, apps, works and products in said storage means in cloud repositories and among said networked repositories, and how to partake in creating, managing and fostering said compilations of relational medical-business data and to disseminate and share said compilations to create, enhance and foster said intelligence based on medicine and science algorithms and logics, how to process, disseminate and sharing said compilations whenever security clearances, requests, grants and denials are exchanged between and among said networked repositories, how to utilize said managed and shared compilations for creating and fostering said cloud intelligence, reconstituent means and said innate security Web in and among said networked repositories;
said cloud intelligence for instructing said processing means for processing requests to access said compilations of relational medical-business data in and among said networked repositories and for executing and managing said mechanism and said innate security Web for protecting said system;
said processing means for processing handshakes of keys and locks and said requests for accessing and using means and associating compilations and for getting and receiving said means and compilations in said cloud repositories and in and among said networked repositories:
said processing means for automatically disseminating and sharing said means, works and products among networked repositories comprising digital images and videos and associating texts generated by said digital cameras;
said networked repositories having requesting repositories for generating requests to access and use said mechanism and works and products in said cloud repositories and among said networked repositories, said requesting networked repositories having individual keys for handshaking with individual locks in said cloud repositories, said requesting networked repositories having individual requests indicating individual access and usage rights of said mechanism and works and products in said cloud repositories and networked repositories;
each of said access and usage rights for specifying how said means, compilations, works and products in said cloud repositories and networked repositories are accessed and used by said requesting repositories.

2. The repositories of servers, computers and networks of mobile communication devices including tablets and smartphones according to claim 1 comprised networked requesting, passive, healthcare dispensing, payers, and servers repositories include those repositories in said networked devices belonging to pharmacies, governments and pharmaceutical corporations and companies and third party payers.

3. The means for rendering, modulating, controlling and dispensing said dispensations and usages possessing an inherent means for automatically generating, calculating and distributing fees payments associating with said dispensations and usages in and among networked repositories according to claim 1 comprised:
a) a plurality of linked interactive relational templates and platforms for generating, editing, adapting, adding, disseminating and sharing compilations of relational medical-business data in and among said networked repositories, said relational templates and platforms attaching a plurality of rendering application software henceforth apps, said apps for generating individual custom and multiple medical-business specialty-specific templates and platforms in individual networked repositories, said templates and platforms comprised:
b) individual repository-specific and repositories-specific interactive scrollable or automatically expanding continua of said compilations, each expanding continuum for automatically uploading in the home page in each view screen said compilations in said continua, templates and platforms, each continuum for getting and receiving relevant compilations and for disseminating and sharing said compilations among said networked repositories, said continua, templates and platforms possessing said first and second operant associating archives for executing said means;
c) said individual continua, templates and templates having attached individual repository-specific control platforms, repositories-specific control platforms and administrator-specific control platforms, said platforms for generating, editing, modulating and controlling said compilations in said continua, templates and platforms and relational medical-business data in said continua, templates, platforms and storage means, said platforms having a function for networking networked repositories;
d) said means having attached access and usage rights;
e) said digital camera means for compiling and sharing relational medical-business data in and among said networked repositories;
f) a plurality of apps comprising commercial computer software for generating diverse on-demand and custom interactive repository-specific and diagnosis-medical history specific templates and platforms for serving specific repositories, said custom templates and platforms are shared among and utilized in and among relevant requesting and passive networked repositories including rendering servers repositories, said plurality is attached to said templates and platforms;
g) selected relational medical-business data linking said relevant sites generated from the selections of associations of interactive said relational medical-business data and relevant interactive anatomical and organ sites of plurality of human images and organ systems in said templates and platforms in said viewing screens in networked devices in particular said mobile communication devices, said storage means for storing said compilations of selections associating with said relational medical-business data relating to relevant networked repositories, said relational medical-business data, said processing means for processing said relational medical-business data relating to relevant networked repositories to be displayed in said scrollable and automatically expanding continua, and for compiling said relational medical-business data stored in said storage means, and said networked repositories to disseminate and share said compilations in and among said networked repositories;
h) said interactive anatomical and organ sites-specific medical-business data for selectively and specifically associating said relational anatomical and organ sites-specific medical-business data with specific relational anatomical and organ sites as relational data in said storage means wherein said associations are repeatedly gotten by and used in and among networked repositories, said templates and platforms for sharing said relational medical-business data with attached and relevant continua in and among said networked repositories, said plurality are linked to said individual continua, and archives of said associations and compilations of relational medical-business data associating with relational anatomical and organ sites-specific medical-business data in and among said storage means, said processing means for getting said archives to be displayed in and among said continua, templates and platforms;
i) inherent means for automatically generating, calculating and distributing fees payments associating with said dispensations and usages comprising individual interactive words, terms and phrases representing individual dispensed amounts, types and characters of dispensed procedures, treatments, services and products including pharmaceutics and usages of said healthcare in said templates, platforms and said storage means, said individual words, terms and phrases are diagnosis-specific and categories-specific words, terms and phrases relating to individual relational medical-business data in said interactive templates and platforms including said second operant associating archives and in compilations in said storage means, each of said words, terms and phrases for causing attached processing mean to scan and match said words, terms and phrases originating from said templates, platforms and storage means with same and similar words, terms and phrases associating with individual fees in dollars and national currencies in relational databases in said storage means, said processing means for calculating and generating compilations of relational medical-business data including said fees payments, debits and credits and tallies and for automatically disseminating and sharing said compilations in said cloud repositories and among relevant networked repositories; and
j) said continua, templates and platforms having i) improving said cloud intelligence, ii) said first and second operant associating archives for executing said means, iii) individual interactive get-function, manage-function, compile-function and share-function icons, buttons and words for linking, associating and expanding said compilations in and among individual repositories and said networked repositories, iv) for getting, managing, compiling and sharing compilations relational medical-business data in and among relevant continua, templates and platforms and v) for getting and sharing said compilations relational medical-business data with cloud repositories.

4. The first operant associating archives according to claim 1 comprised interactive icons, buttons and words in said interactive and expanding continua and linked interactive templates and platforms in said viewing screens, said interactive icons, buttons and words instruct processing means to get and display interactive and expanding continua and linked interactive templates and platforms having said repository-specific and repositories-specific compilations having second operant associating archives from storage means.

5. The second operant associating archives for executing said means according to claim 1 comprised individual anatomical and organ sites represented by numerous interactive 2-dimensional and 3-dimensional human and organ images and images in videos to which individual and duplicate interactive relational medical data are attached, the spatial positions of said individual and duplications referencing said human and organ images in said continua, templates and platforms, said spatial positions for representing instruction in said computer programs for instructing said processing means how to assign spatial specificity to relational spatial-specific labeled medical data associating with said anatomical and organ sites in said storage means, said processing means for assigning adjectives representing said spatial specificity to said selected associating with relevant anatomical or organ site in said compilations in said storage means whenever a medical data in said compilations of relational medical-business data in said templates and platforms was selected by a requesting repository;
individual archives comprising compilations of associations of relational spatial-specific labeled medical data associating with anatomical and organ sites in said storage means and viewing screens, said archives are interactive and adaptable in said viewing screens based on additions and editions in said compilations in said continua, templates and platforms and said storage means; and
said second operant associating archives for enabling said mechanism to operate in said networked mobile communication devices and said second operant associating archives for enabling said mechanism to adroitly execute in all networked devices.

6. The compilations of relational medical-business data according to claim 1 comprised relational databases of relational categories and headings in medical history and fees payments for healthcare dispensations and usages in said storage means in and among said networked repositories.

7. The means for getting, managing, compiling and sharing said means in and among networked repositories according to claim 1 are said individual interactive get-function, manage-function, compile-function and share-function icons, buttons and words imbedded in said interactive electronic continua, templates and platforms.

8. The means for getting, managing including compiling relations of and sharing products of said means according to claim 1 comprised digital images and videos generated by said digital cameras, said images and videos for attaching to relational medical-business data generated in and among said networked repositories of networked devices in particular said networked mobile communication devices for disseminating and sharing said disseminations and shares among networked repositories.

9. The means for getting, managing including compiling relations of and sharing said means according to claim 1 are apps for getting and receiving said relational medical and business data in, from and among said networked repositories.

10. The means for getting, managing including compiling relations of and sharing said means according to claim 1 are individual medical data- and business data-specific blogs in and among said networked repositories.

11. The apps according to claim 1 comprised a plurality of commercial apps for rendering and tailoring interactive custom repository-specific and diagnosis-medical history specific templates and platforms to match and suit peculiar needs of individual repositories and said networked repositories, said apps-rendered templates and platforms are stored, disseminated and adapted in and shared among said networked repositories.

12. The reconstituent means for safeguarding and resurrecting said system and works and products according to claim 1 are apps including mobile apps created by said innovative computer programs by said intelligence in said cloud repositories which disseminated said apps to and to be share among said networked repositories.

13. The cloud intelligence according to claim 1 comprised intelligent medical, healthcare and science logics innate in said compilations of relational medical-business data based on repeated disseminations, sharing, uses and analyses of inclusive and exclusive relational medical-business data in said compilations in said storage means and said continua, templates and platforms in and among said networked repositories including cloud repositories.

14. The inherent security Web according to claim 1 comprised individual adaptable electronic locks and complementary adaptable electronic keys in storage means of said cloud repositories and relevant networked repositories networked to and in storage means of said cloud repositories, each key rendered by processing means instructed by said cloud intelligence comprising a compilation of an encrypted and randomize networked repository identifications, single or multiple-users identifications and demographics data of adaptable sequences of snippets of compilations of relational medical-business data generated by and characterizing each repository stored in said storage means of said cloud repositories, each key is transmitted and attached to a relevant networked repository, same key stored in said cloud repositories is known as a lock, all keys and locks constituting said adaptable security Web.

15. The verification and vigilance protocol according to claim 1 comprised electronic scrutinies and matches known as electronic handshakes of individual keys and matching locks in and among said networked repositories and each electronic handshake for causing said processing means to transmit text and voice messages having security images to appropriate networked repositories for receiving said messages.

16. The reconstituent means for safeguarding and resurrecting according to claim 1 comprised downloads of an adaptable mobile app for safeguarding and resurrecting said system in and among said networked repositories from said cloud repositories, said adaptable mobile app having said mechanism, relational medical data and repository-specific and repositories-specific compilations of relational medical-business data in repository-specific storage means and attaching to processing means of said networked mobile communication devices and other networked devices, said mobile app for forming and enabling said system to operate in and among networked repositories with and without said cloud repositories.

17. In a system for rendering and controlling healthcare through a network, a method rendering, dispensing and controlling healthcare dispensations and usages having a mechanism for rendering, modulating, dispensing and controlling said dispensations and usages utilizing a first and a second operant associating archives and medical history-categories-specific words, terms and phrases to seamlessly and automatically generate, calculate and distribute fees payments associating with said dispensations and usages whenever said renderings, dispensations and usages occurred in and among networked repositories wherein said mechanism rendering, managing and adapting compilations of relational medical-business data based on medical and scientific algorithms and logics in storage means to create and foster a networked-repositories intelligence to instruct said mechanism, to render and foster an inherent security Web utilizing a verification and vigilance protocol to protect said system and a reconstituent means to safeguard and perpetuate said system with and without cloud repositories, said method comprising the steps of:
a) creating said networked repositories comprising cloud rendering-servers repositories henceforth cloud repositories, servers, computers and networks of mobile communication devices including tablets and smartphones having viewing screens including touch-screens and digital camera means for compiling relational medical-business data in and among said networked repositories henceforth networked devices comprising networked repositories having processing means and storage means to store compilations of works and products of said mechanism, digital works and products of said digital cameras attaching to compilations of relational medical-business data generated and compiled in and among said networked repositories;
b) creating and implementing said innovative computer programs attaching to processing means in said cloud repositories to instruct said processing means how to install and utilize said networked-repositories intelligence herein known as cloud intelligence based on intelligent algorithms and logics created and compiled from medicine and healthcare algorithms and logics associating with compilations of relational medical data and relational medical-business data with and without evidence-based medical and scientific data in said networked repositories and to continually and automatically foster and enhance said cloud intelligence based on compilations generated and compiled in and among said networked repositories;
c) said innovative computer programs utilizing said cloud intelligence to instruct said processing means how to create, manage and expand said compilations in said means and storage means in and among said networked repositories, partake in creating, managing and fostering said cloud intelligence and security in and among said networked repositories, to attach access and usage rights to said means, works and products;
d) said innovative computer programs utilizing said cloud intelligence to instruct said processing means to render and store said mechanism, works and products in said cloud repositories and in and among said networked repositories;
e) said cloud repositories rendering and managing linked interactive relational continua, templates and platforms having said first and second operant associating archives, said step comprising processes of:
i) rendering and sending individual repository-specific and repositories-specific interactive scrollable or automatically expanding continua and related templates and platforms of compilations of relational medical-business data to and among said networked repositories, said continua and related templates and platforms automatically and repeatedly uploaded in home pages in said view screens and share said compilations in and among said cloud repositories and networked repositories, said compilations based on multi-medical and -surgical specialties medical history categories and their derivatives are repeatedly generated, added, adapted and expanded in and among said continua, templates and platforms in and among said networked repositories and cloud repositories;
ii) utilizing a plurality of apps in said system to generate diverse on-demand custom interactive repository-specific and diagnosis-medical history specific templates and platforms having said first and second operant associating archives to serve specific networked repositories, and disseminating and sharing said custom templates and platforms among relevant requesting and passive networked repositories including cloud repositories, attaching said custom templates and platforms to said continua, templates and platforms in said storage means;
iii) rendering interactive get-function, manage-function, compile-function and share-function icons, buttons and words in said uploaded interactive electronic continua, templates and platforms to disseminate and share said compilations among said networked repositories;
iv) instructing processing means how to optimize individual inputs including detecting and correcting deficiencies, failures and defects of medical data and business data by networked repositories and how to process, compile and manage said compilations of relational medical-business data of and among networked repositories with stored compilations in said cloud repositories, and to disseminate and share said compilations in and among said networked repositories;
f) attaching individual repository-specific control platforms, repositories-specific control platforms and administrator-specific control platforms to said continua, templates and platforms, said platforms to generate, edit, modulate and control said compilations in said continua, templates and platforms and compilations of relational medical-business data in said continua, templates, platforms and storage means, and to network said repositories by using a networking function in said platforms;
g) said cloud repositories utilizing said cloud intelligence to instruct said processing means to generate, manage and foster said inherent security Web in and among said networked repositories, said cloud repositories render and assign individual electronic keys to relevant networked repositories networked to and in storage means of said cloud repositories, said cloud intelligence instructing processing means to render individual keys by compiling individual networked repositories identifications, single or multiple-users identifications and demographics data and adaptable sequences of snippets of said compilations of relational medical-business data generated by and characterizing individual networked repositories in said storage means of said cloud repositories, to encrypt and randomize said snippets, said cloud repositories to transmit individual keys to relevant individual networked repositories, said keys stored in said cloud repositories are known as locks, said cloud intelligence to instruct said processing means to automatically and constantly update, adapt and encrypt said keys and locks, and to process individual handshakings between individual keys and relevant locks in and among said networked repositories to render purposeful couplings between and among said networked repositories, all keys and locks constituting said adaptable security Web;
h) individual requesting networked repositories transmitting requests to couple between and among networked repositories, said cloud repositories utilizing said verification and vigilance protocol to:
i) scrutinize and match individual keys attaching to individual requesting repositories with corresponding locks to render individual electronic handshakes to grant individual clearances and accesses to coupling requesting and targeted repositories including said cloud repositories;
ii) use said individual electronic handshakes to cause said cloud repositories to transmit individual text and voice messages including security images on said handshakes to requesting and targeted networked repositories;
i) recognizing individual cleared requesting repositories having particular access and usage rights indicating individual particular requests for said means having particular works and products in cloud repositories and between and among networked repositories, said access and usage rights are either granted or denied by said cloud repositories or networked repositories;
j) individual access and usage rights causing said processing means to render said means having particular repository-specific or repositories-specific works and products associating with individual cleared requesting repositories having particular access and usage rights;
k) said processing means uploading said compilations including said first and second operant associating archives from said storage means into said repository-specific and repositories-specific interactive scrollable or automatically expanding continua and related templates and platforms in said viewing screens;
l) said first operant associating archives to provide a plurality of ubiquitous one-step gets said interactive continua, templates and platforms by said requesting repositories;
m) said second operant associating archives to generate, edit, adapt and add relational categories- and headings-specific medical data referencing to medical-specific diagnosis and diagnoses and associating healthcare dispensations and usages incorporating relational spatial-specific labeled medical data associating with anatomical and organ sites relevant to said requesting repositories, and to storing said selected compilations in said storage means of said networked repositories from which compilations including said compilations and archives comprising said compilations of associations of relational spatial-specific labeled medical data associating with anatomical and organ sites are returned and rendered interactive and adaptable in said means in said viewing screens by processing means in and among said cloud repositories and relevant networked repositories, said compilations are disseminated and shared in and among said cloud repositories and relevant networked repositories:
n) said means to depend on said first and second operant associating archives to vitally and adroitly executing said means;
o) whenever said requesting repositories selected said relational medical-business data in said linked interactive relational expandable continua, templates, platforms and said second operant associating archives and submitted said selected having individual diagnosis-specific and categories-specific words, terms and phrases relating to individual relational medical-business data wherein said words, terms and phrases representing individual dispensed amounts, types and characters of dispensations and usages of said healthcare comprising procedures, treatments, services, products including pharmaceutics which are processed by said processing means to said storage means, said processing means automatically generate, calculate and distribute fees payments associating with said dispensations and usages in said cloud repositories based on stored fees payments, debits and credits by scanning and matching said individual words, terms and phrases with same and similar words, terms and phrases associating with individual fees in dollars and national currencies in relational databases in said storage means, and said processing means automatically calculate and compile relational medical-business data having amounts, types and characters of dispensed and used diagnosis-specific and categories-specific associating with said fees payments, debits and credits and tallies in said storage means in said cloud repositories which disseminate and share said compilations in and among relevant networked repositories;
p) said interactive get-function, manage-function, compile-function and share-function icons, buttons and words imbedded in said interactive electronic continua, templates and platforms to disseminate and share said compilations among said networked repositories;
q) said networked repositories downloading and storing an adaptable mobile app from said cloud repositories, said mobile app having said mechanism, relational medical data and repository-specific compilations of relational medical-business data in repository-specific storage means and attaching to processing means of said networked mobile communication devices and said networked devices, said mobile app enables said system to operate in and among networked repositories with and without said cloud repositories, said mobile app in and among networked repositories is a reconstituent means for safeguarding and resurrecting said system and works and products with and without said cloud repositories.

18. In a system for rendering and controlling healthcare through a network by a rendering, modulating, dispensing and controlling system, said system comprised networked rendering repositories coupled to networked cloud rendering repositories, said rendering repositories utilizing and sharing a rendering mechanism for rendering, modulating, dispensing and controlling healthcare dispensations and usages and automatic fees payments associating with said dispensations and usages in and among networked repositories, said rendering mechanism rendering and fostering a networked-repositories intelligence, a first and a second operant associating archives to operate said mechanism to render works and products of said mechanism, a reconstituent means to safeguard and perpetuate and an inherent security Web having a verification and vigilance protocol to protect said systems in and among said networked repositories, said method comprising steps of:
a) creating said networked repositories comprising cloud repositories, repositories of servers, computers and networks of mobile communication devices including tablets and smartphones having viewing screens including touch-screens and digital camera means for compiling relational medical-business data in and among said networked repositories henceforth networked devices comprising networked repositories having processing means and storage means to store compilations of works and products of said mechanism, digital works and products of said digital cameras attaching to compilations of relational medical-business data generated and compiled in and among said networked repositories;
b) implementing innovative computer programs to instruct processing means how to install and utilize cloud intelligence based on intelligent algorithms and logics created and compiled from medicine and healthcare algorithms and logics associating with compilations of relational medical data and relational medical-business data with and without evidence-based medical and scientific data in and among said networked repositories and to continually and automatically foster and enhance said cloud intelligence in and among said networked repositories;
c) said innovative computer programs utilizing said cloud intelligence to instruct said processing means how to create, manage and expand said compilations in said means and among storage means in and among said networked repositories, partake in creating, managing and fostering said cloud intelligence, reconstituent means and security Web in and among said networked repositories, to attach access and usage rights to said means, works and products;
d) said innovative computer programs utilizing said cloud intelligence to instruct said processing means to render and store said mechanism, works and products in said cloud repositories and in and among said networked repositories;
e) said cloud repositories rendering and managing linked interactive relational continua, templates and platforms having said first and second operant associating archives, said step comprising processes of:
i) rendering and sending individual repository-specific and repositories-specific interactive scrollable or automatically expanding continua and related templates and platforms of compilations of relational medical-business data to and among said networked repositories, said continua and related templates and platforms automatically and repeatedly uploaded in home pages in said view screens and share said compilations in and among said cloud repositories and networked repositories, said compilations based on multi-medical and -surgical specialties medical history categories and their derivatives are repeatedly generated, added, adapted and expanded in and among said continua, templates and platforms in and among said networked repositories and cloud repositories;
ii) utilizing a plurality of apps in said system to generate diverse on-demand custom interactive repository-specific and diagnosis-medical history specific templates and platforms having said first and second operant associating archives to serve specific networked repositories, and disseminating and sharing said custom templates and platforms among relevant requesting and passive networked repositories including cloud repositories, attaching said custom templates and platforms to said continua, templates and platforms in said storage means;
iii) rendering interactive get-function, manage-function, compile-function and share-function icons, buttons and words in said uploaded interactive electronic continua, templates and platforms to disseminate and share said compilations among said networked repositories;
iv) instructing processing means how to optimize individual inputs including detecting and correcting deficiencies, failures and defects of medical data and business data by networked repositories and how to process, compile and manage said compilations of relational medical-business data of and among networked repositories with stored compilations in said cloud repositories, and to disseminate and share said compilations in and among said networked repositories;
f) attaching individual repository-specific control platforms, repositories-specific control platforms and administrator-specific control platforms to said continua, templates and platforms, said platforms to generate, edit, modulate and control said compilations in said continua, templates and platforms and compilations of relational medical-business data in said continua, templates, platforms and storage means, and to network said repositories by using a networking function in said platforms:
g) said cloud repositories utilizing said cloud intelligence to instruct said processing means to generate, manage and foster said inherent security Web in and among said networked repositories, said cloud repositories render and assign individual electronic keys to relevant networked repositories networked to and in storage means of said cloud repositories, said cloud intelligence instructing processing means to render individual keys by compiling individual networked repositories identifications, single or multiple-users identifications and demographics data and adaptable sequences of snippets of said compilations of relational medical-business data generated by and characterizing individual networked repositories in said storage means of said cloud repositories, to encrypt and randomize said snippets, said cloud repositories to transmit individual keys to relevant individual networked repositories, said keys stored in said cloud repositories are known as locks, said cloud intelligence to instruct said processing means to automatically and constantly update, adapt and encrypt said keys and locks, and to process individual handshakings between individual keys and relevant locks in and among said networked repositories to render purposeful couplings between and among said networked repositories, all keys and locks constituting said adaptable security Web;
h) individual requesting networked repositories transmitting requests to couple between and among networked repositories, said cloud repositories utilizing said verification and vigilance protocol to:
i) scrutinize and match individual keys attaching to individual requesting repositories with corresponding locks to render individual electronic handshakes to grant individual clearances and accesses to coupling requesting and targeted repositories including said cloud repositories;
ii) use said individual electronic handshakes to cause said cloud repositories to transmit individual text and voice messages including security images on said handshakes to requesting and targeted networked repositories;
i) recognizing individual cleared requesting repositories having particular access and usage rights indicating individual particular requests for said means having particular works and products in cloud repositories and between and among networked repositories, said access and usage rights are either granted or denied by said cloud repositories or networked repositories;
j) individual access and usage rights causing said processing means to render said means having particular repository-specific or repositories-specific works and products associating with individual cleared requesting repositories having particular access and usage rights;
k) said processing means uploading said compilations including said first and second operant associating archives from said storage means into said repository-specific and repositories-specific interactive scrollable or automatically expanding continua and related templates and platforms in said viewing screens;
l) said first operant associating archives to provide a plurality of ubiquitous one-step gets said interactive continua, templates and platforms by said requesting repositories;
m) said second operant associating archives to generate, edit, adapt and add relational categories- and headings-specific medical data referencing to medical-specific diagnosis and diagnoses and associating healthcare dispensations and usages incorporating relational spatial-specific labeled medical data associating with anatomical and organ sites relevant to said requesting repositories, and to storing said selected compilations in said storage means of said networked repositories from which compilations including said compilations and archives comprising said compilations of associations of relational spatial-specific labeled medical data associating with anatomical and organ sites are returned and rendered interactive and adaptable in said means in said viewing screens by processing means in and among said cloud repositories and relevant networked repositories, said compilations are disseminated and shared in and among said cloud repositories and relevant networked repositories;
n) said means to depend on said first and second operant associating archives to vitally and adroitly executing said means;
o) whenever said requesting repositories selected said relational medical-business data in said linked interactive relational expandable continua, templates, platforms and said second operant associating archives and submitted said selected having individual diagnosis-specific and categories-specific words, terms and phrases relating to individual relational medical-business data wherein said words, terms and phrases representing individual dispensed amounts, types and characters of dispensations and usages of said healthcare comprising procedures, treatments, services, products including pharmaceutics which are processed by said processing means to said storage means, said processing means automatically generate, calculate and distribute fees payments associating with said dispensations and usages in said cloud repositories based on stored fees payments, debits and credits by scanning and matching said individual words, terms and phrases with same and similar words, terms and phrases associating with individual fees in dollars and national currencies in relational databases in said storage means, and said processing means automatically calculate and compile relational medical-business data having amounts, types and characters of dispensed and used diagnosis-specific and categories-specific associating with said fees payments, debits and credits and tallies in said storage means in said cloud repositories which disseminate and share said compilations in and among relevant networked repositories;
p) said interactive get-function, manage-function, compile-function and share-function icons, buttons and words imbedded in said interactive electronic continua, templates and platforms to disseminate and share said compilations among said networked repositories;
q) said networked repositories downloading and storing an adaptable mobile app from said cloud repositories, said mobile app having said mechanism, relational medical data and repository-specific compilations of relational medical-business data in repository-specific storage means and attaching to processing means of said networked mobile communication devices and said networked devices, said mobile app enables said system to operate in and among networked repositories with and without said cloud repositories, said mobile app in and among networked repositories is a reconstituent means for safeguarding and resurrecting said system and works and products with and without said cloud repositories.
